(19) United States
(12) Patent Application Publication
(10) Pub. No.: US 2020/0220998 A1
(43) Pub. Date: Jul. 9, 2020

(54) METHOD AND APPARATUS FOR QUICKLY CAPTURING IMAGES WITH ONE HAND

(71) Applicant: Timothy E. Bridges, Huntington Beach, CA (US)

(72) Inventor: Timothy E. Bridges, Huntington Beach, CA (US)

(21) Appl. No.: 16/295,360

(22) Filed: Mar. 7, 2019

Related U.S. Application Data
(60) Provisional application No. 62/790,375, filed on Jan. 9, 2019.

(51) Int. Cl. H04N 5/225; H04N 5/232

(52) U.S. Cl. CPC H04N 5/2253; H04N 5/23216

(57) ABSTRACT

A method and apparatus for quickly capturing photographic images with one hand. The apparatus includes a wearable ring, camera, electronics, and a charging base. The ring may be configured to be worn on the right or left index finger (or any other digit including any toe), aligning the camera over the phalanx bone. The ring may incorporate electronic sensors on the surfaces or other location to detect the forming of a fist to enable image capture, and the touching of the thumb or other digit or body part to capture images. Electronics support inductive charging using the charging base, as well as image capture, storage, and transfer to a smart phone for later processing.

### CROSS-REFERENCE TO RELATED APPLICATION

This application claims the benefit of the filing date of Provisional Application, Ser. No. 62/790,375, filed on Jan. 9, 2019, which is incorporated herein by reference.

### BACKGROUND

### Field

The present disclosure relates generally to electronic wearables and, in particular, to capturing of photographic images. Still more particularly, the present disclosure relates to a method and apparatus for pointing a wearable image capture device with a hand, and operating it one handed to capture one or more still-pictures and/or videos.

### Background

A wide variety of wearable electronic devices are dedicated to image and video capture. They are generally mounted on a helmet or chest, and run all the time, capturing continuous video while performing an activity such as bike riding, motor cycle riding, or patrolling in the case of law enforcement. As a result, they require larger physical size for mounting to clothing or a person, and battery life. They are clearly visible on a person's body, usually placed with the expectation of capturing video of pending activities.

Although these devices may be useful, their bulk and obvious nature make them inconvenient for daily personal life when life's unexpected turns may present a sudden and unexpected opportunity to quickly capture a desired image. There are also a number of “spy” cameras and “nanny” cameras, which may or may not be worn on a person, and which generally are not pointable in real-time for rapid image capture.

There are also many smart phones with camera capabilities, which can be enabled with a screen swipe, then pointed, then activated with a screen touch. This usually requires some time to access the phone, two hands to swipe, point, and touch a screen while holding the smart phone. This can be inconvenient when a passing image-opportunity presents itself suddenly and unexpectedly, and the user has only seconds to capture it before it is lost.

Therefore, it would be desirable to have a method and apparatus that takes into account some of the issues discussed above, as well as other possible utility improvements.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

The wearable one-handed image-capture method and apparatus provide an electronic image-capture capability in the time it takes a user to point their fist. One would simply make a fist with the proximal phalanx of the index finger pointing in the intended direction, and squeeze to take photos one handed.

Although the image-capturing device is exemplified as being worn on the index finger of a user, it shall be understood that the wearable image-capturing device may be worn on any finder or toe (“digit” generally) of a user.

There are a number of unexpected situations that occur where people wish they could quickly take a one-handed photo. One example is an interesting pet photo, or any interesting scene while you are driving by and see only for a moment. At these times, you would like to capture what is happening instantly, without accessing a phone, swiping to unlock the camera, or hoping a wearable or mountable camera is pointed the right way. Later it could be shared on social media sites.

Another example is protecting yourself in a hit and run situation, or any physical accosting by a person or loose animal, by capturing the perpetrator's image for use by law enforcement. Another example is a city representative, e.g., animal control or security person on the run, reacting immediately to a situation and not having time to swipe a phone and point with both hands. With a wearable one-handed image-capture apparatus, they can capture an image while on the run by pointing their fist in the desired direction. Police may see an assault under way as they are biking or driving, and want to capture an image at that moment of discovery, for evidence, without swiping a phone, or pointing a wearable and clicking. Other situations could include a bicycle crossing in front of a car or a passing wildlife. The military may benefit by capturing evidentiary images in hard to access areas or directions, in real-time, where a typical wearable camera or dash cam would not work.

An aspect of the disclosure relates to an apparatus comprising: a number of pressure sensors, structures, image capture, and electronic components configured to enable one-handed image capture; and a base component configured to accommodate the apparatus and charge it.

Another aspect of the disclosure relates to a method for aligning an image capture device along the longitudinal axis of the index finger's proximal phalanx using structural shank and shoulders which contact the adjacent fingers.

Yet another aspect of the disclosure relates to an image-capture apparatus, including a housing including a shank configured to receive a first digit of a user; a camera coupled to the housing; and one or more sensors coupled to the housing for actuating image- or video-capturing operation of the camera.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the description embodiments are intended to include all such aspects and their equivalents.

### BRIEF DESCRIPTION OF THE DRAWINGS

FIG. 1 illustrates front, left side, right side, and top views of an exemplary image-capturing ring apparatus of the present invention.

FIG. 2 illustrates front, left side, right side, and top views of an exemplary battery charging base for the image-capturing ring apparatus of the present invention.

FIG. 3 illustrates a functional block diagram of an exemplary image-capturing ring apparatus and associated battery charging base of the present invention. The ring functions are depicted in the upper portion of the diagram, while the charging base is depicted in the lower portion.

FIG. 4 depicts the image-capturing ring apparatus mounted on the battery charging base to effectuate battery charging in accordance with the present invention fits.

FIG. 5 illustrates the method of use for the present invention. It depicts a top view and a side view of the hand position associated with capturing an image.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

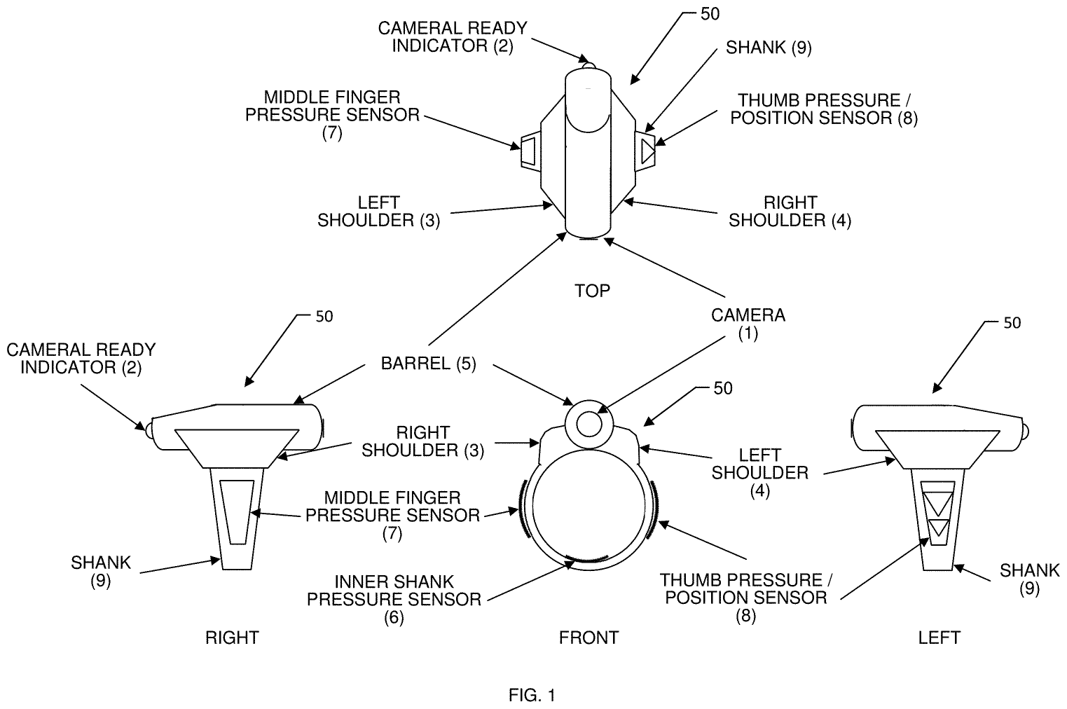

Described herein is a wearable one-handed image capture ring apparatus 50 and a separate battery charger base 10. The image-capturing ring apparatus 50 is depicted in FIG. 1. The ring apparatus 50 includes a shank 9 used to attach the ring to the index finger generally aligned coaxial with the phalanx bone. The ring apparatus 50 further includes right shoulder 3, and left shoulder 4, which collectively, are used to support the barrel 5 on top of the wearer's finger. The image-capturing apparatus 50 further includes a camera 1 located within a barrel 5 portion of the housing used to capture images. Electronic components for the image-capturing apparatus 50 are enclosed within the ring apparatus housing; for example, within the shank 9, shoulders 3, 4, and barrel 5. A camera-ready indicator light 2 may be located at the back of the barrel 5.

An inner shank pressure sensor 6 located on the inside bottom of the shank 9 is configured to detect pressure from the index finger as it contracts when a fist is formed (detecting the contraction of the proximal phalanx segment of the user's index finger) or when the bottom of the ring 50 is pushed against a fixed object by the index finger. A middle finger pressure sensor 7 may be located on the right outside of the shank 9 to detect pressure from the middle finger when it presses against the index finger as a fist is closed or when both the index and middle fingers made to push against each other. If the image-capturing apparatus 50 is configured to be worn by the left-index, the middle finger pressure sensor 7 may be located on the left outside of the shank 9. In one exemplary configuration, when both sensors 6 and 7 are actuated as a fist forms, the camera or image-taking-operation function is enabled. The shapes of the right shoulder 3 and left shoulder 4 are designed to ensure the camera 1 is automatically lined up at the top of the index finger as a fist is formed.

A thumb pressure and position sensor 8 may be located on the left outside of the shank to detect thumb pressure. Again, if the image-capturing apparatus 50 is configured to be worn by the left-index, the thumb pressure sensor 8 may be located on the right outside of the shank 9. In another exemplary configuration, actuating the sensor 8 activates the camera to capture the image. Additionally, the thumb pressure and position sensor 8 can detect sliding (e.g., generally-vertical) movement of the user's thumb along the shank in order to trigger multiple consecutive image captures. The present embodiment may capture any (e.g., predefined) number of images (e.g., 10) approximately at a set of consecutive time intervals apart (e.g., 0.15 second apart).

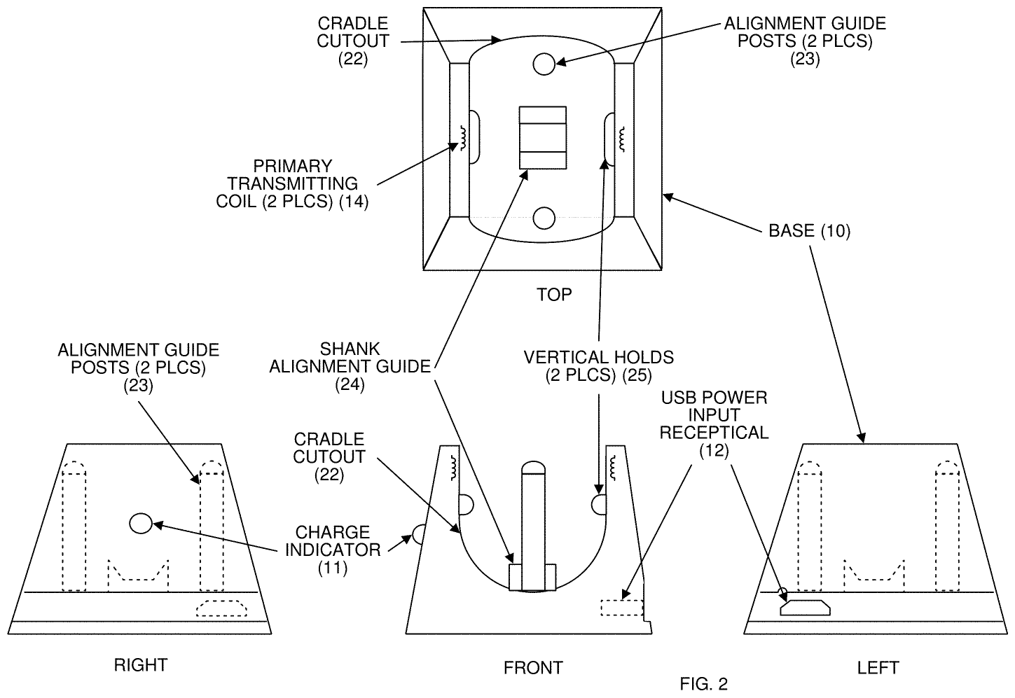

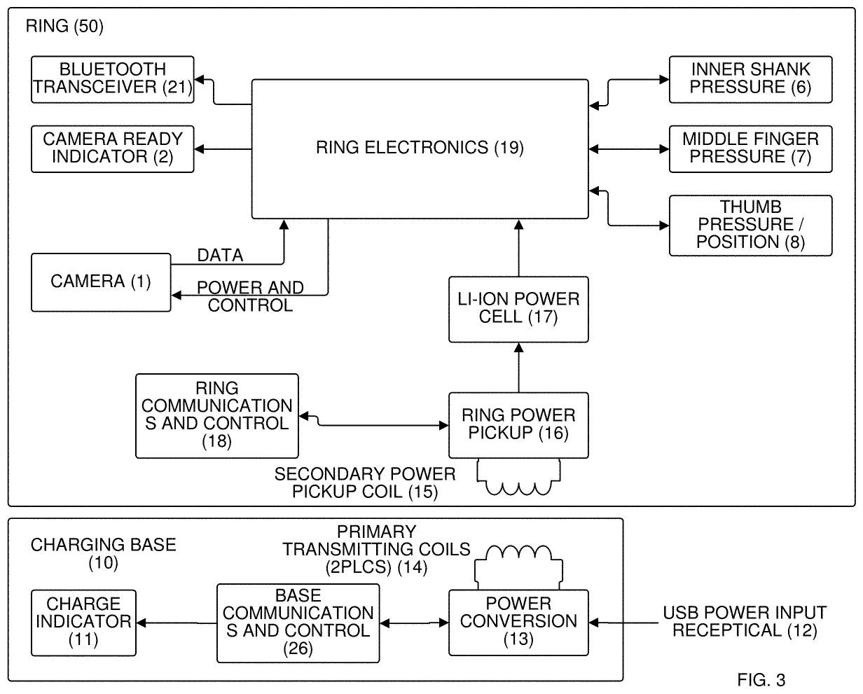

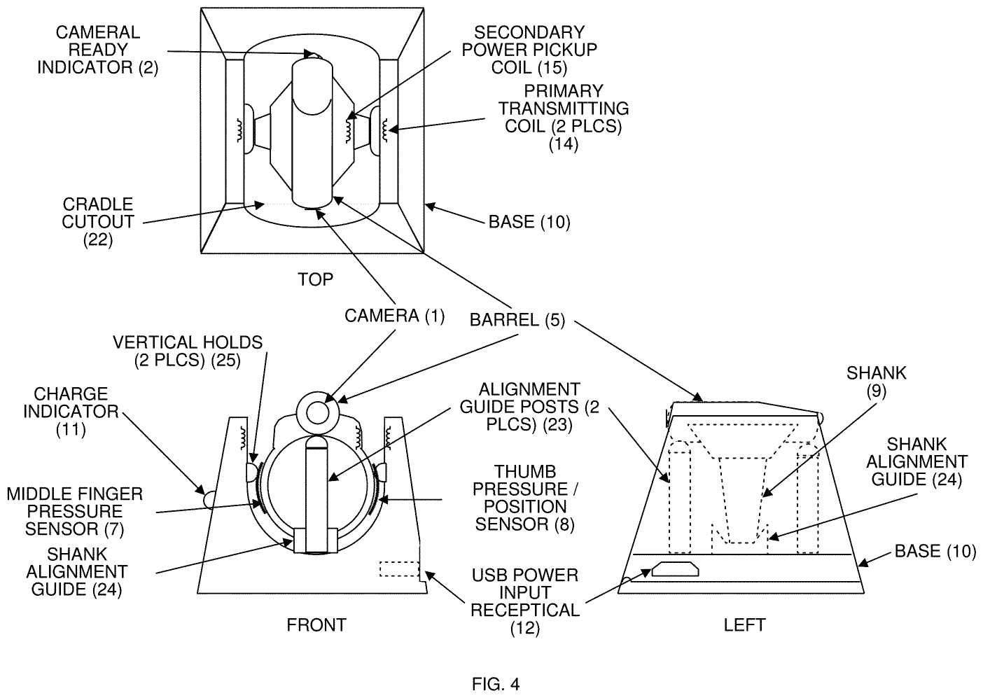

The battery charging base 10 is illustrated in FIG. 2 and described as follows. The base 10 may be trapezoidal in shape (or other shape) and comprised of front, back, top, bottom, left, and right sides. The battery charging base 10 includes a cradle cutout 22 that accommodates the image-capturing ring apparatus 50 for storage and charging of its internal battery 17 (shown in FIG. 3). There are two alignment guide posts 23 with rubber tips which support the front and back ends of the ring 50 when it is inserted into the charging base 10. The shank alignment guide 24 accommodates the bottom center of the ring's shank 9 as the ring is inserted into the base 10. Together these alignment features are configured to ensure the ring apparatus 50 remains upright in the base, and the primary transmitting coils 14 in base 10 are aligned with the ring power pickup coil 15 (shown in FIG. 3). The alignment features 23, 24, and the primary transmitting coils 14 are symmetrical so the ring apparatus 50 may be placed in the charging base 10 facing either front or back, and it will still perform the securing and battery charging functions. The vertical holds 25 are located on either side of the cradle cutout 22, and hold the ring apparatus 50 in place by friction-fit once the user inserts the ring past the midpoint of shank 9. This is further described with reference to FIG. 4, showing the ring apparatus 50 inserted into the charging base 10.

The right side of base 10 may include a charging indicator 11 to indicate when the ring internal battery 17 is charging and is fully charged. This function is explained further with reference to FIG. 3, the functional block diagram of the ring 50 and the charger 10. The base 10 (e.g., on the left-side) may include a Universal Serial Bus (USB) or other type of Input Power receptacle 12 to accept power for use by the base 10 as further with reference to FIG. 3. Internal electronic components may be located in the space between the bottom and sides of base 10 and the cradle cutout 22.

The electronic components are embedded on or within the housing of the ring apparatus 50 and charging base 10. These components are schematically shown in FIG. 3, and further described as follows. USB input power 12 (or other power source (e.g., wall outlet)) is provided to power conversion 13 in the charging base 10. This power is used to energize primary transmitting coils 14 in accordance with Qi or other standard for wireless charging. There are two primary transmitting coils 14 to accommodate both possible ring insertion orientations (forward and backward). Alignment guide posts 23, shank alignment guide 24, and vertical holds 25 ensure the primary transmitting coils 14 and the ring's secondary power pickup coil 15 are properly oriented so resonant frequency is maintained for power transfer, regardless of which orientation the ring is placed in the base. In other words, there will be a primary transmitting coil 14 in the base, opposite the secondary power pick up coil 15 in the ring, whether the ring is place in the base facing forward or backward. Base communications and control 26 monitors the power conversion and energy draw via backscatter information, in accordance with the Qi or other standard for wireless charging. When the base 10 is charging the ring battery 17, the charge indicator 11 will blink green. When charging is complete, the charge indicator 11 will be a solid green. When the ring is not inserted into the base 10, no power transfer is detected by base communications and control 26, and the charge indicator 11 is not illuminated.

When the ring's secondary power pick coil 15 is inductively energized in accordance, for example, with the Qi or other standard for wireless charging, electrical power will be delivered to the Li-Ion power cell 17, thereby charging it. Energy will also be delivered to the ring communications and control 18, which senses power levels of the power cell 17, and controls the delivery of power to charge it to capacity. The Li-Ion power cell 17 provides power to the ring electronics 19 which contains firmware, memory, and processing capacity to manage the ring functions. Ring electronics 19 is always on, in dormant mode, awaiting command inputs from the user.

There are three pressure sensors 6, 7, and 8 configured to operate the image-capturing ring apparatus 50, such as actuating image-capturing operations and/or other operations (e.g., pairing, uploading, updates, settings, configuration, etc.). As an example of such operation, when the ring apparatus 50 is worn by the user, the inner shank pressure 6 will register a value representative of the nominal wearing pressure. When the user clenches his/her index finger when forming a fist or pushes the bottom of the ring against a fixed object, the inner shank pressure 6 will rise, providing one of two required enabling signals to the ring electronics. When the user squeezes his/her middle finger against the right side of the shank, the middle finger pressure 7 will increase in pressure, providing the second of two required enabling signals to the ring electronics 19. When the ring electronics 19 receives both enabling signals (Boolean AND), it will enable the camera 1. The order in which inner shank pressure 6 and middle finger pressure 7 register pressure does not matter. At this point, the Phalanx Snapshot ring 50 is enabled and the camera-ready indicator 2 is illuminated by the ring electronics, indicating so. When the user presses his/her thumb against the shank's left side, the thumb pressure/position 8 will rise. This tells the ring electronics 19 to capture a single image using the camera 1. If the thumb pressure/position indicator 8 senses the users thumb sweeping along the shank, from top to bottom, the ring electronics 19 will capture a series of images using the camera 1. The ring apparatus 50 may be configured to provide a maximum (e.g., predefined) number of images in a single sweep event of 10 (or other number), evenly distributed over the length of the thumb pressure / position sensor 8 at about, for example, 0.15 s intervals or other duration.

In the present embodiment, images are stored to non-volatile memory located in the ring electronics 19 in accordance with JPEG or other standard. Up to 50 or other number of images may be stored. As additional images beyond 50 (or other limit) are added, the older ones may be discarded from memory in a “first in, first out” fashion. Other embodiments based on technology and cost could include more photos and/or video. In this case, the thumb pressure/position sensor 8 would be configured to indicate video if the user maintains pressure on the terminal end of the sweep area of the sensor.

Bluetooth, WiFi, or USB may be used to upload the entire image buffer to an iPhone. For example, Bluetooth pairing may be accomplished by holding the ring between two fingers (not worn typically, but worn also applies) such that both sides of the shank have pressure exerted on them. Thus, the middle finger pressure 7 and thumb pressure/position 8 are both activated while inner shank pressure 6 is not. When this configuration is held for five (5) seconds (or other defined duration), the ring electronics 19 activates Bluetooth pairing via the Bluetooth transceiver 21 and flashes camera ready indicator 2 yellow. Once pairing is achieved, which can take up to 20 minutes or other duration, the camera-ready indicator 2 flashes green. The images are uploaded to the iPhone at this time. If the ring has been previous paired, then after the five (5) or other second hold, the images will transfer immediately, assuming the smart device is in range.

When the ring's Li-ion power cell 17 reaches 20% or other threshold power level, the ring electronics will flash the cameral ready indicator yellow at a 1 Hz or other rate, even when in dormant mode, to indicate low battery. The ring will continue to operate as usual until power is depleted. The images stored in non-volatile RAM will be retained.

When the ring 50 is not in use, or needs to be charged, it is inserted into the base 10 as shown in FIG. 4. The ring 50 is inserted from above. In the present embodiment, the vertical holds 25 are rollers that will rotate and flex to accommodate the diameter of the shank 9. Once the ring 50 is depressed past the center of shank 9, the vertical holds 25 will spring back and hold the ring down. The alignment guides 23 provide support at the front and back of the ring ensuring it remains horizontally in position. Finally, shank alignment guide 24 centers the bottom of the shank in the base 10. The combination of these features is configured to ensure the ring is aligned in the base such that a primary transmitting coil 14 is aligned with the ring's secondary power pickup coil 15. This method of alignment works regardless of which direction the ring is facing, as shown in the top view of FIG. 4. That is, the ring can face the front or the back of the base 10, and at least one of the primary transmitting coils 14 will be aligned with the secondary power pick coil 15 for charging.

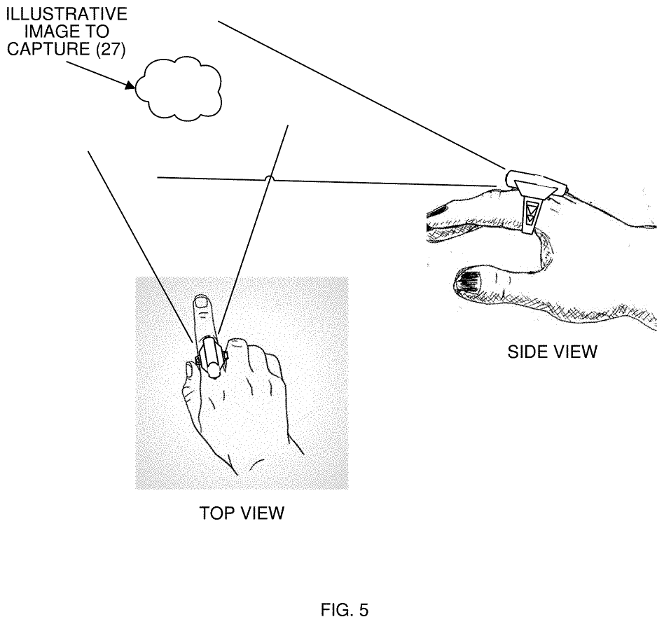

The ring 50 would be worn on the index finger with the lens pointed away from the body as shown in FIG. 5. It could be continuously worn like a piece of jewelry, or worn on occasions where the user, police, military anticipates random activities during their day which they would like to capture as images. The ring 50 would be in dormant mode, nominally. When the user experiences a situation where an image is needed instantly, they make a fist with four fingers and point at the scene, and operate it as described above, to capture it as in FIG. 5. The field of view may be −140 degrees or other, wider than typical smart phone, allowing for broader capture. The camera 1 is biased upward slightly to minimize intrusion of second knuckle into the image. Standard editing tools on a computer or iPhone would be used to extract the pertinent portions of the image. Ring battery life may be approximately 2 days. At night it would sit in a charging base to recharge the ring power cell. The ring 50 may be water resistant to four (4) feet of depth or other depth. Other embodiments could be ruggedized for law enforcement and military use. Further embodiments could be configured with an infrared source to enable use in the dark.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. An apparatus comprising: a number of pressure sensors, structures, image capture, and electronic components configured to enable one-handed image capture; and a base component configured to accommodate the apparatus and charge it.

2. The apparatus of claim 1, wherein the pressure sensors, structures, image capture, sensors, and electronics are configured as a wearable ring such that the image capture device is mounted coaxially with proximal phalanx of index finger to facilitate generally correct directional pointing using a user's natural fist and arm movement for image alignment.

3. The apparatus of claim 1, wherein the pressure sensors are configured to enable and then trigger image capture by sensing the formation of a fist and articulation of the thumb on the same hand.

4. A method for aligning an image capture device along the longitudinal axis of the index finger's proximal phalanx using structural shank and shoulders which contact the adjacent fingers.

5. An image-capture apparatus, comprising:
a housing including a shank configured to receive a first digit of a user;
a camera coupled to the housing; and
one or more sensors coupled to the housing for actuating image- or video-capturing operation of the camera.

6. The image-capture apparatus of claim 5, wherein the one or more sensors are actuated by movement of the first digit.

7. The image-capture apparatus of claim 6, wherein the one or more sensors are actuated by movement of a second digit of the user.

8. The image-capturing apparatus of claim 7, wherein the first digit and the second digit are on a same hand of the user.

9. The image-capturing apparatus of claim 8, wherein the first digit includes an index finger and the second digit includes a thumb.

10. The image-capturing apparatus of claim 9, wherein the first digit includes an index finger and the second digit includes a middle finger.

11. The image-capturing apparatus of claim 5, wherein the first digit includes a toe of the user.

12. The image-capturing apparatus of claim 5, wherein the one or more sensors includes a first pressure sensor situated on an interior surface of the shank, the first pressure sensor configured to be activated by the first digit.

13. The image-capturing apparatus of claim 12, wherein the one or more sensors includes a second pressure sensor situated on an exterior surface of the shank, the second pressure sensor configured to be activated by a second digit, the first and second digits being on a same hand of the user.

14. The image-capturing apparatus of claim 13, wherein the first digit includes an index finger and the second digit includes a middle finger.

15. The image-capturing apparatus of claim 14, wherein activation of the first and second pressure sensors by the index and middle fingers, respectively, enable the camera.

16. The image-capturing apparatus of claim 15, wherein the one or more sensors includes a third pressure sensor situated on the exterior surface of the shank, wherein the third pressure sensor is configured to be activated by a thumb on the same hand of the user, and wherein activation of the third pressure sensor causes the camera to capture one or more images or a video.

17. The image-capturing apparatus of claim 16, wherein activating the third pressure sensor by the thumb sliding across the pressure sensor causes the camera to take a series of images spaced apart in time by a predefined interval.

18. The image-capturing apparatus of claim 5, wherein the one or more sensors includes:
a first pressure sensor situated on an interior surface of the shank and configured to be activated by the first digit, wherein the first digit is an index finger of the user;
a second pressure sensor situated on an exterior surface of the shank and configured to be activated by a middle finger of the user, the index finger being on a same hand as the middle finger; and
a third pressure sensor situated on the exterior surface of the shank and configured to be activated by thumb of the user, the thumb being on the same hand.

19. The image-capturing apparatus of claim 18, wherein activation of a pair of the first, second, and third pressure sensors enable the camera, and activation of the remaining one of the first, second, and third pressure sensors causes the camera to capture one or more images or video.

20. The image-capturing apparatus of claim 5, wherein the camera center line-of-sight makes an acute angle with a longitudinal axis of the first digit of the user.
